(19) United States
(12) Patent Application Publication
(10) Pub. No.: US 2007/0082139 A1
(43) Pub. Date: Apr. 12, 2007

(54) Process for the flame-retardant treatment of fiber products

(76) Inventors: Salman Dermeik, Augsburg (DE); Karl-Heinz Lemmer, Augsburg (DE); Reinhold Braun, Schwabmunchen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/580,739

(22) PCT Filed: Nov. 25, 2004
(86) PCT No.: PCT/EP04/13357

§ 371 Date: May 26, 2006

(30) Foreign Application Priority Data
Dec. 5, 2003 (EP) 03027959.0

(51) Int. Cl. B05D 3/02

(52) U.S. Cl. 427/393.3

(57) ABSTRACT

In the case of fiber products which contain from 20 to 100% by weight of cellulose fibers, flame-retardant properties can be achieved by applying a polyethylenimine and a phosphonic acid to the fiber products or to precursors thereof. The precursors of the fiber products may be aqueous fiber suspensions which are further processed to give paper or fiberboards.

The invention relates to a process for the flame-retardant treatment of fiber products.

It is known that fiber products, such as, for example, fiberboards or fiber mats, or precursors of fiber products can be treated with certain products in order to impart desired properties to them. Thus, for example, R. M. Rowell in “Proceedings, International Workshop on Frontiers of Surface Modification and Characterization of Lignocellulosic Fibers” (Sweden May 30-31, 1996) (ISBN 91-7197-593-4), describes the chemical modification of lignocelluloses.

DE-A 30 03 648 and DE-A 42 44 194 describe the use of nitrogen-containing condensates in papermaking.

EP-A 542 071 describes wood preservatives which contain copper salts and which may additionally contain polyethylenimine and/or phosphonic acid.

S. C. Juneia. “Stable and Leach-Resistant Fire Retardants for Wood” in “Forest Products Journal”, Vol. 22, No. 6 (1972) pages 17-23, disclose the flame-retardant treatment of wood materials. In “Wood Research”, No. 72 (1972) pages 72 to 89, S. Ishihara and T. Maku report on the flame-retardant treatment of wood and filter paper with cationic products.

The processes known from the prior art for the treatment of fiber products are not optimum in relation to the flame-retardant treatment of products containing cellulose fibers. This applies in particular when the cellulose-containing fiber products are further processed by a wet process to give fiberboards or fiber mats. Often, an adequate flame-retardant treatment cannot be achieved here by known processes. The reason for this may be, inter alia, that it is not possible to bind a sufficient amount of the flame-retardant product to the fiber material.

It was the object of the present invention to develop an improved process for the flame-retardant treatment of fiber products, it also being possible in particular to impart good flame-retardant effects to fiber products having a high proportion of cellulose fibers which were produced by a wet process. In wet processes, the problems are in fact often greater than in dry processes, so that, in known wet processes, there is the danger that the flame-retardant component will be washed out in the course of the production of the fiber product. In this case, a deterioration in the flame-retardant properties of the end article usually occurs.

The object was achieved by a process for the flame-retardant treatment of a fiber product which contains from 20 to 100% by weight of cellulose fibers, based on the weight of the anhydrous fiber product, the fiber product or preferably a precursor thereof being treated in succession or simultaneously with a component A and a component B, component A being a branched polyethylenimine which contains primary, secondary and tertiary amino groups and which has a weight average molecular weight in the range from 5000 to 1 500 000, preferably from 10 000 to 1 000 000, and in which the numerical ratio of secondary amino groups to primary amino groups is in the range from 1.00:1 to 2.50:1 and the numerical ratio of secondary amino groups to tertiary amino groups is in the range from 1.20:1 to 2.00:1,

component A being a mixture of such polyethylenimines,

component B being a phosphonic acid of the formula (I), (II) or of the formula (III)

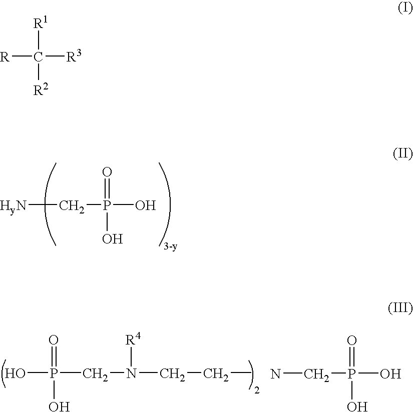

in which, in the formulae (I), (II) or (III), the hydrogen atom in up to 50% of the OH groups bonded to phosphorus may be substituted by an alkali metal or an ammonium group, but preferably 100% of these OH groups being present in unneutralized form,

or component B being a mixture of compounds which are selected from compounds of the formulae (I), (II) or (III),

in which

y may assume the values 0, 1 or 2 and preferably has the value 0,

R¹ is H or OH,

R is a linear or branched alkyl radical which contains 1 to 7 carbon atoms when R¹ is OH and 3 to 7 carbon atoms when R¹ is H,

R² being

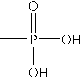

R³ being H or R², preferably R², and

all radicals R⁴, independently of one another, being H or

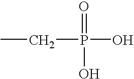

or being a radical of the formula (IV)

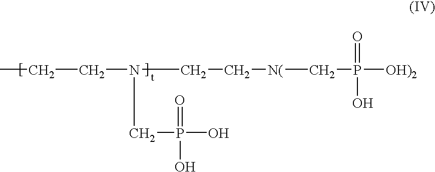

it being preferable if from 50 to 100% of all radicals R⁴ present are

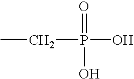

t being 0 or a number from 1 to 10.

In the context of the invention described here, fiber products are understood as meaning products which contain from 20 to 100% by weight of cellulose fibers. This range for the content of cellulose fibers is based on the anhydrous fiber product Fiber products may be finished products, such as, for example, paper, pressboards (e.g. medium density fiberboards or high density fiberboards), which may be used in the furniture industry or packaging industry, in the building industry and in automotive construction. Such fiberboards or pressboards often also contain a fixing binder in addition to fibers, the fibers being the component which determines the strength of the pressboards. The process according to the invention which is presented here is preferably used for achieving flame-retardant properties of such fiberboards or pressboards. For many intended uses of such pressboards, flame-retardant properties are required. For the production of such fiberboards, cellulose fibers can be mixed with additives, such as binding resins or water repellents, and optionally water is added in order to obtain an aqueous fiber suspension. The mixture thus obtained is shaped, dried, and pressed under the action of heat and pressure to give boards.

Although in principle the process according to the invention can also be carried out on the finished end product, a preferred embodiment comprises carrying it out during the process for the production of the finished fiber products, i.e. on a precursor of the finished fiber product. This precursor is preferably an aqueous suspension which contains cellulose fibers and optionally further additives, for example those of the abovementioned type. In association with the process according to the invention, such fiber suspensions may be, for example, precursors in papermaking. However, they are preferably precursors in the production of fiberboards or fiber mats.

The processing of such aqueous suspensions of cellulose fibers to give fiberboards, for example pressboards or insulating boards, is effected by the so-called wet process. The process according to the invention can advantageously be used particularly in the case of wet processes of this type, the aqueous fiber suspension, for example a pulp, being treated with the components A and B. Here, for example, the fiber suspension is poured onto a filter screen, a thin layer being formed, starting from which the finished fiber product is produced by drying and pressing under the action of heat and pressure.

Said fiber suspension (precursor), which contains cellulose fibers, water and optionally the abovementioned further components, usually comprises from 0.3 to 15% by weight of cellulose fibers, preferably from 0.5 to 1.5% by weight. This proportion of cellulose fibers must be such that, after removal of the water, the finished fiber product contains from 20 to 100% by weight of cellulose fibers, based on the fiber product without water and without the components A and B. It is advantageous to carry out the process according to the invention not on the finished fiber product (fiberboard, paper) but on a precursor thereof. This precursor is a cellulose fiber-containing product which is formed during the production of the finished fiber product and is further processed to give the finished fiber product. In particular, aqueous cellulose fiber suspensions are suitable as precursors for carrying out the process according to the invention. Carrying out the process according to the invention not on the finished fiber product (although this is also possible in certain cases) but on a precursor of said type is advantageous because effective flameproofing is usually achieved thereby. It is assumed that this is due to the fact that, in this case, better binding of the component A and/or B to the cellulose fibers is achieved, promoted by the subsequent action of heat and pressure.

An advantageous embodiment of the process according to the invention is characterized in that the cellulose fibers of the fiber product are present partly or completely in the form of lignocellulose-containing fibers. Lignocellulose is a composite vegetable material comprising cellulose, polyoses and lignin.

The chemical composition of lignocellulose-containing fibers is described in the literature reference mentioned at the outset (R. M. Rowell, ISBN 91-7197-5934), 2nd page, “Features of Lignocellulosics”, and furthermore in EP-A 406 783.

In the process according to the invention, a fiber product or, preferably, a precursor thereof is treated in succession or simultaneously with a component A and a component B. Thus, A and B can be applied simultaneously, for example in the form of a mixture which contains the components A and B. However, this method is less preferred and in many cases is even unsuitable. Rather, it is more advantageous to apply the components A and B in succession, it furthermore being preferable to apply the component A (polyethylenimine) earlier to the fiber product than component B (phosphonic acid). It has in fact been found that in many cases a more effective flame-retardant effect can be achieved with this procedure than with the other process variants mentioned.

It has already been mentioned that it is preferable to apply the components A and B not to the finished fiber product but to a precursor thereof. This precursor is preferably an aqueous suspension which contains the cellulose fibers.

In an analogous manner, it is frequently advantageous if the component A and/or the component B is applied to the fiber product or the precursor thereof not in pure form but in the form of a mixture with water. It is particularly advantageous if both component A and component B are applied in each case in the form of a mixture which contains component A or component B and additionally water. Thus, component A can be used, for example, in the form of a mixture which contains from 50 to 500 parts by weight of water per 100 parts by weight of component A, and component B in the form of a mixture which contains from 20 to 300 parts by weight of water per 100 parts by weight of component B. One or both of these mixtures may contain further components, for example polymaleic acid or partly hydrolyzed polymaleic anhydride. The addition of partly or completely hydrolyzed polymaleic anhydride is, when such an additive is used, preferably in the range from 1 to 5% by weight, based on the total mixture which contains the component A or the component B and water.

If polymaleic acid or partly hydrolyzed polymaleic anhydride is used, it is preferably added to a mixture which contains component A and water. In a number of cases, this addition results in an increase in the permanence of the flame-retardant effect. This might be due to the fact that the additional use of partly or completely hydrolyzed polymaleic anhydride leads to better fixing of the comment A and/or component B on the fiber product.

It may furthermore be advantageous, particularly when the fiber product or the precursor thereof contains from 10 to 25% of lignin, additionally to apply a partial ester of orthophosphoric acid to the fiber product or the precursor thereof. The application of this partial ester can be effected simultaneously with the application of the component A or of the component B or, preferably, separately therefrom in a separate operation. The amount of orthophosphoric partial ester which is applied is preferably in the range from 2 to 10%, based on anhydrous fiber product or anhydrous precursor. Suitable phosphoric partial esters are, inter alia, mono- or diesters of orthophosphoric acid having 6 to 12 carbon atoms in the alcohol component of the ester, or mixtures of such mono and diesters. An example of this is diisooctyl phosphate or diphenyl phosphate or bis(tert-butylphenyl) phosphate. By the addition of such esters, it is often possible to increase the flame-retardant effect.

Preferably neither component A nor component B nor the mixtures of component A or component B and water contains or contain metals or metal compounds, apart from insignificant impurities. This is an advantage for cost reasons and for environmental reasons and moreover avoids the coloring of the finished fiber products by metal ions. Although the hydrogen atom in up to 50% of the hydroxyl groups bonded to phosphorus can optionally be replaced by alkali metal or ammonium ions in component B, this is not preferred.

The application of component A, of component B or of a mixture which also contains water in addition to component A or component B to the fiber product or the precursor thereof can be effected by any desired methods. It is most advantageous to use an aqueous suspension, which contains cellulose fibers, as a precursor and to apply a mixture which contains water and component A and then a mixture which contains water and component B to this precursor. Regardless of whether the components A and B are each applied as a mixture with water or in pure form to the fiber product or the precursor, in a preferred embodiment of the process according to the invention the weight ratio of the amount of component A applied to the fiber product or to the precursor thereof to the amount of component B applied is in the range from 1:1.3 to 1:4.0.

The amount of component A and component B which are applied to the fiber product or the precursor thereof is preferably such that from 3 to 10% by weight of component A and from 7 to 20% by weight of component B, based on anhydrous fiber product, are present on the finished fiber product.

The component A is a polyethylenimine. As usual in the case of polymers, this is usually not a product which consists just of identical molecules but which is a mixture of products of different chain length. In the case of polyethylenimines, there is also the fact, known from the literature, that a mixture of branched polymers whose individual molecules also differ in the number of branching units is usually present. This is expressed by the ratio of the number of secondary to primary amino groups and to tertiary amino groups, which ratio is explained in more detail below.

Polyethylenimines are products known from the literature. They can be prepared, inter alia, by reacting 1,2-ethylenediamine with 1,2-dichloroethane. For carrying out the novel process, polyethylenimines which can be prepared by polymerization of unsubstituted aziridine (ethylenimine) are preferably used. This polymerization can be carried out by known methods, optionally with addition of acidic catalysts, e.g. hydrochloric acid, and optionally in the presence of water.

Polyethylenimines suitable for the process according to the invention are available on the market, for example from BASF, Germany (LUPASOL® grades and POLYMIN® grades) or from Nippon Shokubai Co. Ltd., Japan.

U.S. Pat. No. 6,451,961 B2 and U.S. Pat. No. 5,977,293 describe polyethylenimines and processes for the preparation thereof. The polyethylenimines described there can be used for carrying out the process according to the invention provided that they fulfill the conditions mentioned above and in claim 1. Furthermore, D. A. Tomalia et al., in “Encyclopedia of Polymer Science and Engineering, Vol. 1. Wiley N.Y. 1985, pages 680-739, describe suitable polyethylenimines and processes for their preparation.

Polyethylenimines, their preparation and properties are also described in D. Horn. “Polyethylenimine-Physicochemical Properties and Applications, in “Polymeric Amines and Ammonium Salts”. Goethals E. J., Pergamon Press: Oxford, N.Y. 1980, pages 333-355.

The polyethylenimines suitable as component A for the process according to the invention are branched. This means that the polymer which has terminal groups of the formula
H₂N—CH₂—CH₂—

and, within the polymer chain, units of the formula
—CH₂—CH₂—NH—CH₂—CH₂—NH—

additionally contains units of the formula

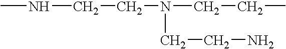

within the chain.

The polymer thus contains primary, secondary and tertiary amino groups.

In order for the procedure of the process according to the invention to give good effects with regard to flame-retardant properties of the fiber products, the numerical ratios of the individual amino groups must assume values within a certain range. Thus, in component A, the ratio of the number of secondary amino groups to the number of primary amino groups must be in the range from 1.00:1 to 2.50:1, and the ratio of the number of secondary amino groups to the number of tertiary amino groups must be in the range from 1.20:1 to 2.00:1. These numerical values can be controlled via the parameters in the preparation of the polyethylenimines. The values present in a certain polyethylenimine or mixture of polyethylenimines for said numerical ratios of the various amino groups can be determined by means of ¹³C-NMR spectroscopy. This is explained in “T. St. Pierre and M. Geckle, ¹³C-NMR-Analysis of Branched Polyethylenimines, J. Macromol. SCI.-CHEM., Vol. A 22 (5-7). pages 877-887 (1985)”.

Component A, which, as is usual in the case of polymers, is usually a mixture of polymers and consists of polyethylenimine molecules of different molecular weights and different degrees of branching, has a weight average molecular weight in the range from 5000 to 1 500 000, preferably in the range from 10 000 to 1 000 000. The values present in the individual case for this average molecular weight can be determined by methods as disclosed in the polymer literature, for example by means of gel permeation chromatography and detection by means of light scattering. The following procedure may be adopted for this purpose:

The column used comprises one or more “PSS-Suprema” types (obtainable from “Polymer Standards Service GmbH”, Mainz, Germany) which are adjusted to the intended molecular weight range; eluent 1.5% strength formic acid in water; multiangle scattered light detector MALLS (likewise obtainable, inter alia, from “Polymer Standards Service”); an internal standard can optionally additionally be used.

The values mentioned above and in claim 1 for the weight average molecular weight are based on this method of determination.

The average molecular weight of polyethylenimines can be controlled by variation of the parameters in their preparation.

In a preferred embodiment of the process according to the invention, component A is a polyethylenimine which is formed by polymerization of ethylenimine and has the following structure (formula (V))

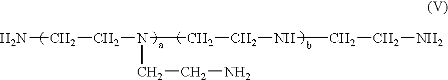

the polymerization optionally being acid-catalyzed,

it being possible for the individual units which contain tertiary amino groups and the individual units which contain secondary amino groups to be arbitrarily distributed over the polymer chain, b being greater than a, and a and b having values such that the conditions mentioned in claim 1 for the molecular weight and for the numerical ratios of the amino groups to one another are fulfilled

or component A being a mixture of such polyethylenimines.

As mentioned, component A is usually a mixture of polyethylenimines. In the abovementioned preferred embodiment, component A is therefore usually a mixture of compounds of the formula (V). The values of a and b in the compounds of the formula (V) must of course be chosen so that the values, determined with the mixture, for the numerical ratios of the individual amino groups to one another and for the average molecular weight are in the ranges stated above and in claim 1. As mentioned, these values can be controlled via the parameters in the preparation of the polyethylenimines.

Component B is a phosphonic acid of the formula (I), of the formula (II) or of the formula (III)

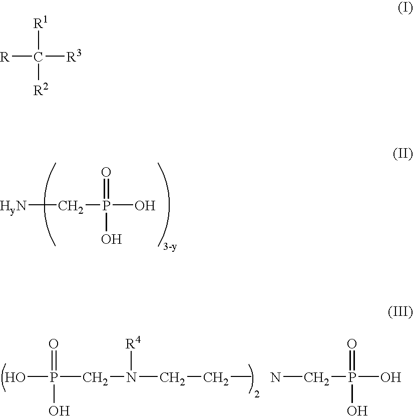

Component B may also be a mixture of compounds which are selected from compounds of the formula (I), of the formula (II) and of the formula (III).

In formula (I), R is a linear or branched alkyl radical. Where the radical R¹ mentioned below is a hydroxyl group, this alkyl radical contains 1 to 7 carbon atoms. If R¹ is hydrogen, the radical R contains 3 to 7 carbon atoms.

The radical R¹ in formula (I) is H or OH.

In formula (I), the radical R² is the radical

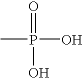

The radical R³ in formula (I) may be hydrogen. Preferably, however, it is a radical R². This ensures that the content of phosphorus, based on the finished fiber product, is higher than when R³═H, with the result that improved flameproofing usually results.

In formula (II), y may assume the values 0, 1 or 2. y preferably has the value 0, which, analogously to the case described above, results in an increase in the phosphorus content based on the fiber product.

All radicals R⁴ present in compounds of the formula (III) are, independently of one another, hydrogen or

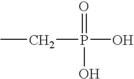

or a radical of the formula (IV)

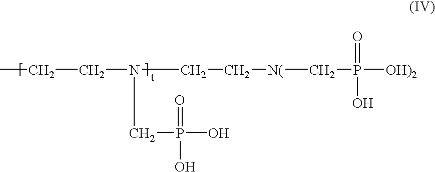

In this formula (IV), t is 0 or is a number from 1 to 10. Preferably, from 50 to 100% of all radicals R⁴ present are

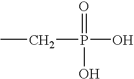

Not all phosphonic acids present in component B need be present in completely unneutralized form. Rather, in up to 50% of the OH groups present and bonded to phosphorus, the acidic hydrogen atoms may be replaced by alkali metal or ammonium ions. Preferably, however, all phosphonic acids of component B are present in completely unneutralized form so that all OH groups are therefore present in acidic form.

Phosphonic acids of the formulae (I), (II) and (III) are commercial products, for example Masquol P 210-1 from Protex-Extrosa or Briquest 301-50 A from Rhodia or the products Cublen D50 (from Zschimmer & Schwarz, Germany), or Diquest 2060 S (from Solutia, Belgium). Phosphonic acids of the formulae (I), (II) and (III) can be prepared by methods generally known from the literature.

A particularly advantageous embodiment of the process according to the invention is characterized in that component B is a mixture of phosphonic acids of the formula (I) and of the formula (II), both of which are present in completely unneutralized form.

In such a mixture, the mixing ratio of phosphonic acid of the formula (I) and phosphonic acid of the formula (II) may assume any desired values. Thus, the weight ratio of the two types of phosphonic acid may assume values of from 0:100 to 100:0. Good results are obtained, for example, if a mixture which contains from 70 to 95% by weight of a compound or a mixture of compounds of the formula (I) and from 5 to 30% by weight of a compound or of a mixture of compounds of the formula (II) is used as component B. It is particularly advantageous here to use a compound of the formula (I), in which

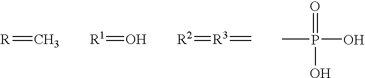

and to use a compound of the formula (II) in which y is 0.

It is possible to subject the fiber products produced by the process according to the invention to a recycling process, said fiber products first being comminuted and then being processed again to give fiberboards or pressboards. It is frequently desired or required for these fiberboards or pressboards produced in this manner in turn to have flame-retardant properties. Said recycling process can be carried out, for example, in such a way that the fiberboards or pressboards are comminuted so as to give particles of about 1×1 cm, which are then washed with water or with water which contains one or more inorganic salts. A precursor of the desired final fiber product is then produced again. This precursor is once again preferably an aqueous suspension which contains the fibers.

It has been found that, if, after comminution, the particles were washed only with pure, e.g. distilled, water, this precursor can in many cases be processed again under the action of heat and pressure to give the finished fiber products in the form of fiberboards or pressboards having satisfactory flame-retardant properties, without a treatment with a flame-retardant composition being required again. However, it is also possible to adopt a procedure in which, after the comminution of the fiber products, washing is effected with water which contains one or more inorganic salts, in particular alkaline earth metal salts. Thus, washing can be effected, for example, with tap water. In this case, depending on the salt content of the tap water, it is possible that the flame-retardant properties of the fiberboards or pressboards produced as end products are no longer sufficient unless a flame-retardant composition is applied again. It has been found that said end products acquire satisfactory flame-retardant properties if a component B is applied again after washing of the comminuted particles with salt-containing water.

A preferred embodiment of the process according to the invention is therefore characterized in that a precursor of the fiber product is treated simultaneously or in succession with a component A and a component B, the component A preferably being applied earlier than the component B, and that this precursor is then further processed under the action of heat and pressure to give a fiberboard or pressboard, and this fiberboard or pressboard is then comminuted and is washed with water which contains one or more inorganic salts, then treated again with a component B and further processed under the action of heat and pressure to give a fiberboard and pressboard.

Thus, a process as claimed in one or more of claims 1 to 8 is first carried out and then a recycling process of the type described.

Component B applied again during this recycling process is of the same type as described above. For this purpose too, those members of component B which have been mentioned above as being preferred are once again suitable.

The amount of component B which is to be applied again in the recycling process in order to achieve the desired, flame-retardant effect depends on the process conditions, for example on the type and amount of the water with which washing was carried out beforehand.

The precursor, which is preferably an aqueous fiber suspension in the described recycling process too, can be treated with a component B according to the process described above and then further processed to give fiberboards or pressboards.

The invention is now illustrated in more detail by embodiments.

### EXAMPLE 1

### According to the Invention

1a) Preparation of a Mixture Which Contains Component A:

4.8 kg of a commercially available aqueous solution (LUPASOL® P, BASF, Germany), which contained 50% by weight of water and 50% by weight of polyethylenimine, were mixed with 4.8 kg of water and 0.35 kg of a 50% strength aqueous solution of hydrolyzed polymaleic anhydride. The prepared mixture thus contained about 24% by weight of component A.

1b) Preparation of a Mixture Which Contains Component B.

9.2 kg of an aqueous solution which contained 40% by weight of water and 60% by weight of a phosphonic acid of the abovementioned formula (I) (where

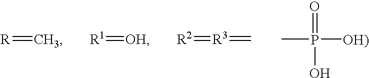

were combined with 0.8 kg of an aqueous solution which contained 50% by weight of water and 50% by weight of a phosphonic acid of the formula (II) (where y=0). The prepared mixture thus contained about 59% by weight of component B.

1c) Treatment of Aqueous Fiber Suspensions (=Precursors of Fiber Products)

Two different aqueous suspensions which contained cellulose fibers were prepared (=suspensions 1 and 2).

For the preparation of suspension 1, 10 g of fiber raw material was suspended in 300 g of water at room temperature with stirring. (The fiber raw material consisted of about 90% by weight of cellulose fibers and 10% by weight of lignin.) This suspension was then diluted with water to a total weight of 1050 g with stirring.

For the preparation of suspension 2, 10 g of a fiber raw material was suspended in 600 g of water with stirring. (This fiber raw material consisted of 70-75% by weight of cellulose fibers and 25-30% by weight of lignin).

After the treatment with components A and B, which is described below, the products obtained from the suspensions 1 and 2 were further treated as follows:

First, the products were filtered with suction over a suction filter and were pressed, a considerable part of the water being removed. Thereafter, some of the samples were pressed at room temperature and a pressure of 35 kp/cm² for 3 minutes and then dried for 20 minutes at 120° C. and then conditioned for 10 minutes at room temperature. Some other samples were pressed not at room temperature but at elevated temperature. These samples were then no longer dried. The weight of all samples thus obtained was then determined.

In each case a plurality of samples of suspension 1 and of suspension 2 were treated, prior to pressing, with components A and B, the component A being applied in all cases in the form of the mixture obtained according to example 1a) and component B in the form of the mixture obtained according to example 1b). In all cases, component A was applied earlier than component B. In the case of some samples, diisoctyl phosphate (DIOP) was additionally applied, in particular before the application of component B.

Moreover, in 2 cases (=“Sample 1” and “Sample 2”), only either component A or component B was applied, and the other of the two components was not used. Samples 1 and 2 are accordingly comparative samples not according to the invention.

Table 1 below shows the amounts of suspension 1 and suspension 2 used, the amounts of components A and B and optionally DIOP used, and the conditions of the pressing and drying process and the weight of the finished fiberboards. The combustion time designated as “CT” in the right column of table 1 is a measure of the flame-retardant effect of the combination of component A and component B used in the process according to the invention.

The “CT” designates the time in seconds for which the relevant sample continues to burn after it was exposed to a flame for 15 seconds and this flame was then removed.

A higher value for “CT” thus means poorer flame-retardant properties of the sample.

TABLE 1

| | Fiber | | Amount of | Amount of | | | | | |
|---|---|---|---|---|---|---|---|---|---|
| | suspension | | mixture | mixture | Amount of | Pressing | Drying | Weight (in g) | |
| | | Amount | Example 1a | Example | DIOP | at | 20 min. | after pressing/ | CT |
| Sample | No. | (in g) | (in g) | 1b (in g) | (in g) | 35 kp/cm² | 120° C. | drying | (sec) |
| 1 | 1 | 1050 | 3.4 | — | — | 3 min. RT | ⊕ | 9.8 | >60 |
| 2 | 1 | 1050 | — | 2.4 | — | 3 min. RT | ⊕ | 9.4 | >60 |
| 3 | 1 | 1050 | 3.4 | 2.4 | — | 3 min. RT | ⊕ | 12.1 | 3 |
| 4 | 1 | 1050 | 3.4 | 2.4 | — | 3 min. | ⊖ | 12.5 | 0 |
| | | | | | | 140° C. | | | |
| 5 | 1 | 1050 | 3.4 | 4.8 | — | 3 min. RT | ⊕ | 12.1 | 0 |
| 6 | 2 | 600 | 3.4 | 2.4 | — | 3 min. RT | ⊕ | 10.5 | 6 |
| 7 | 2 | 600 | 3.4 | 2.4 | 0.8 | 3 min. RT | ⊕ | 11.2 | 0 |

In the column “Pressing”, “RT” denotes room temperature. Where there is a “⊕” in the “Drying” column, the stated drying was carried out, “⊖” means: no drying.

It is clearly evident that the samples 3 to 7 treated by the process according to the invention have substantially better flame-retardant properties than the samples 1 and 2 (comparative experiments not according to the invention). Moreover, a comparison of samples 6 and 7 shows that, in the case of higher lignin contents (suspension 2) in the fiber suspension, addition of DIOP can result in a further improvement.

### EXAMPLE 2

### According to the Invention

This example relates to the possibility, described above and in claim 9, of subjecting a fiberboard which had been produced according to example 1 to a recycling process. “Sample 3”, whose production conditions are shown in table 1 for example 1, was used for this purpose. 4 specimens of this “sample 3” were further processed under various conditions. The end products obtained from these 4 specimens are referred to below as “fiberboard 2a or 2b or 2c or 2d”.

First, the 4 specimens of “sample 3” were comminuted, particles of about 1 cm long and 1 cm wide being obtained. These were washed with tap water, after which in each case 1050 g of a fiber suspension were prepared by adding tap water. Different amounts of a component B in the form of a mixture, which is described under example 1b), were added to this suspension with stirring at room temperature. In the case of the 4 specimens which were further processed to give fiberboards 2a to 2d, the amounts of mixture according to example 1b) which are described in table 2 below were added to the respective fiber suspensions.

After addition of component B (in the form of mixture 1b)), the 4 fiber suspensions were stirred further for 10 minutes at room temperature, then filtered with suction and pressed, a substantial part of the water obtained being removed. The fiber products obtained were then pressed for 3 minutes at room temperature and a pressure of 35 kp/cm² to give fiberboards, which were then dried for 20 minutes at 120° C. at atmospheric pressure and conditioned for 10 minutes at room temperature.

Table 2 below shows, for the 4 fiberboards, the amount of “mixture 1b” which had been added before pressing of the fiber suspension, and the values, determined with the 4 fiberboards, for the combustion time (CT) in seconds. For an explanation of the term “combustion time”, cf. example 1.

TABLE 2

| | Amount of “mixture 1b” | |
|---|---|---|
| Fiberboard | per 1050 g of fiber | |
| No. | suspension | CT (sec) |
| 1 | 1.0 g | 2 |
| 2 | 0.75 g | 5 |
| 3 | 0.5 g | 10 |
| 4 | 0 | completely |
| | | combusted |

It is evident that, under these conditions (washing with tap water), fiberboard 4, which was not produced by the recycling process according to the invention (no further application of a component B), had unsatisfactory combustion properties or flame-retardant effects. The greater the amount of component B) used, the better are the flame-retardant properties of the fiberboards. Depending on the process parameters (for example, amount and composition of the wash water) and depending on the required extent of the flame-retardant properties of the finished fiberboards, the amount of component B) which has to be added again to the suspension varies.

1. A process for the flame-retardant treatment of a fiber product which contains from 20 to 100% by weight of cellulose fibers, based on the weight of the anhydrous fiber product, the fiber product or a precursor thereof being treated in succession or simultaneously with a component A and a component B, component A being a branched polyethylenimine which contains primary, secondary and tertiary amino groups and which has a weight average molecular weight in the range from 5000 to 1 500 000, and in which the numerical ratio of secondary amino groups to primary amino groups is in the range from 1.00:1 to 2.50:1 and the numerical ratio of secondary amino groups to tertiary amino groups is in the range from 1.20:1 to 2.00:1,
or component A being a mixture of such polyethylenimines,
component B being a phosphonic acid of the formula (I), (II) or of the formula (III) 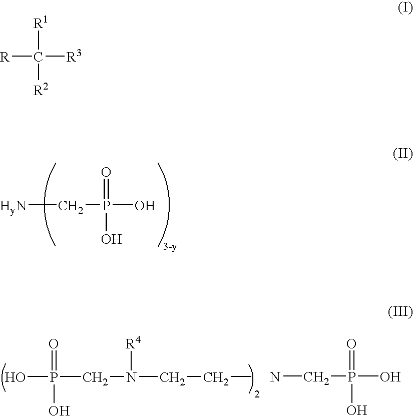
in which, in the formulae (I), (II) or (III), in up to 50% of the OH groups bonded to phosphorus the hydrogen atom may be substituted by an alkali metal or an ammonium group,
or component B being a mixture of compounds which are selected from compounds of the formulae (I), (II) or (III),
in which
y may assume the values 0, 1 or 2
R¹ is H or OH,
R is a linear or branched alkyl radical which contains 1 to 7 carbon atoms when R¹ is OH and 3 to 7
carbon atoms when R¹ is H,
R² being 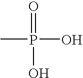
R³ being H or R², and
all radicals R⁴independently of one another, being H or 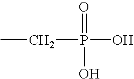
or being a radical of the formula (IV) 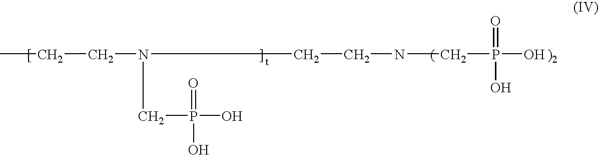
t being 0 or a number from 1 to 10.

2. The process as claimed in claim 1, wherein component B is a mixture of phosphonic acids of the formula (I) and of the formula (II), both of which are present in completely unneutralized form.

3. The process as claimed in claim 1, wherein component A is a polyethylenimine which is formed by polymerization of ethylenimine and which has the structure (V) 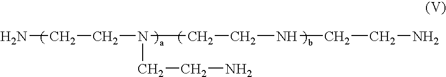
the polymerization optionally being acid-catalyzed,
it being possible for the individual units which contain tertiary amino groups and the individual units which contain secondary amino groups to be arbitrarily distributed over the polymer chain,
b being greater than a and a and b having values such that the conditions, mentioned in claim 1, for the molecular weight and for the numerical ratios of the amino groups to one another are fulfilled or component A being a mixture of such polyethylenimines.

4. The process as claimed in claim 1, wherein the weight ratio of the amount of component A applied to the fiber product or to the precursor thereof to the amount of component B applied is in the range from 1:1.3 to 1:4.0.

5. The process as claimed in claim 1, wherein component A and/or component B are applied in the form of a mixture with water to the fiber product or to a precursor thereof.

6. The process as claimed in claim 1, wherein the precursor of the fiber product is present as an aqueous suspension of fibers.

7. The process as claimed in 1, wherein neither component A nor component B contains metals or metal compounds.

8. The process as claimed in claim 1, wherein, in addition to the components A and B, polymaleic acid or partly neutralized polymaleic acid and/or a partial ester of orthophosphoric acid is also applied to the fiber product or the precursor thereof.

9. The process as claimed in claim 1, wherein a precursor of the fiber product is treated simultaneously or in succession with a component A and a component B, and this precursor is then further processed under the action of heat and pressure to give a fiberboard or pressboard, this fiberboard or pressboard is then comminuted and is washed with water which contains one or more inorganic salts, then treated again with a component B and further processed under the action of heat and pressure to give a fiberboard and pressboard.

10. The process as claimed in claim 1, wherein component B is a phosphonic acid in which 100% of the OH groups bonded to phosphorus are present in unneutralized form.

11. The process as claimed in claim 1, wherein y has the value 0.

12. The process as claimed in claim 1, wherein R³ is R².

13. The process as claimed in claim 1, wherein 50 to 100% of all radicals R⁴ present are

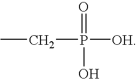

14. The process as claimed in claim 9, wherein component A is applied earlier than the component B.
